(19) United States
(12) Patent Application Publication
(10) Pub. No.: US 2024/0311654 A1
(43) Pub. Date: Sep. 19, 2024

(54) MODEL-BASED COMPREHENSION OF LOG DATA

(71) Applicant: International Business Machines Corporation, Armonk, NY (US)

(72) Inventors: Suranjana Samanta, Bangalore (IN); Debanjana Kar, Kolkata (IN); Amitkumar Manoharrao Paradkar, Mohegan Lake, NY (US); Prateeti Mohapatra, Bangalore (IN); Seema Nagar, Bangalore (IN); Jae-Wook Ahn, Nanuet, NY (US); Mudhakar Srivatsa, White Plains, NY (US)

(21) Appl. No.: 18/121,891

(22) Filed: Mar. 15, 2023

(51) Int. Cl. G06N 5/02; G06F 16/21

(52) U.S. Cl. CPC G06N 5/02; G06F 16/212

(57) ABSTRACT

Techniques are described regarding log data comprehension in a computing environment. An associated computer-implemented method includes inducting data into a knowledge base associated with a log comprehension machine learning knowledge model in order to configure a common log schema. The method further includes extracting at least one key-value pair from a log file including input data associated with at least one downstream application and deriving at least one value feature and any key signal associated with the at least one key-value pair. The method further includes applying the log comprehension machine learning knowledge model in order to compare data associated with the at least one key-value pair extracted from the log file with knowledge base node key-value pair data. The method further includes creating mapping results formatted according to the common log schema and compatible with the at least one downstream application based upon the model application.

### BACKGROUND

The various embodiments described herein generally relate to log data comprehension. More specifically, the various embodiments relate to comparing log file data to inducted knowledge base data via a log comprehension machine learning knowledge model in order to create mapping results for the log file data compatible with at least one downstream application.

### SUMMARY

The various embodiments described herein provide techniques associated with log data comprehension in a computing environment. An associated computer-implemented method includes inducting data into a knowledge base associated with a log comprehension machine learning knowledge model in order to configure a common log schema. The method further includes extracting at least one key-value pair from a log file including input data associated with at least one downstream application, deriving at least one value feature associated with the at least one key-value pair, and deriving any key signal associated with the at least one key-value pair. The method further includes applying the log comprehension machine learning knowledge model in order to compare data associated with the at least one key-value pair extracted from the log file with knowledge base node key-value pair data and, based upon the model application, creating mapping results formatted according to the common log schema and compatible with the at least one downstream application. In an embodiment, the method includes transmitting the mapping results to the at least one downstream application. In an additional embodiment, the method includes updating the knowledge base responsive to log file mapping feedback associated with the at least one downstream application.

According to one or more embodiments, inducting data into the knowledge base includes extracting a plurality of key-value pairs from a log aggregator dataset including semi-structured data, deriving at least one value feature associated with the plurality of key-value pairs, deriving any key signal associated with the plurality of key-value pairs, and adding a node to a plurality of nodes of the knowledge base for each of the plurality of key-value pairs, wherein the node includes the at least one value feature and any key signal derived for the key-value pair. In an embodiment, inducting data into the knowledge base further includes updating the knowledge base in accordance with the common log schema by pruning at least one node among the plurality of nodes. In an additional embodiment, inducting data into the knowledge base includes updating the knowledge base in accordance with the common log schema by merging multiple nodes among the plurality of nodes. In a further embodiment, inducting data into the knowledge base includes updating the knowledge base in accordance with the common log schema by splitting a single node among the plurality of nodes. In a further embodiment, inducting data into the knowledge base includes updating the knowledge base responsive to user feedback.

According to one or more further embodiments, extracting the plurality of key-value pairs from the log aggregator dataset includes flattening the log aggregator dataset, normalizing any universal entity in the flattened log aggregator dataset, and parsing the plurality of key-value pairs from the flattened log aggregator dataset. In an embodiment, deriving the at least one value feature associated with the plurality of key-value pairs includes categorizing by value type one or more of the plurality of key-value pairs. In an additional embodiment, deriving the at least one value feature associated with the plurality of key-value pairs includes deriving at least one regular expression associated with the plurality of key-value pairs.

According to one or more further embodiments, extracting the at least one key-value pair from the log file includes flattening the log file, normalizing any universal entity in the flattened log file, and parsing the at least one key-value pair from the flattened log file. In an embodiment, deriving the at least one value feature associated with the at least one key-value pair includes categorizing by value type one or more of the at least one key-value pair. In an additional embodiment, deriving the at least one value feature associated with the at least one key-value pair includes deriving at least one regular expression associated with the at least one key-value pair.

One or more additional embodiments pertain to a computer program product including a computer readable storage medium having program instructions embodied therewith. According to such embodiment(s), the program instructions are executable by a computing device to cause the computing device to perform one or more steps of and/or to implement one or more embodiments associated with the above recited computer-implemented method. One or more further embodiments pertain to a system having at least one processor and a memory storing an application program, which, when executed on the at least one processor, performs one or more steps of and/or implements one or more embodiments associated with the above recited computer-implemented method.

### BRIEF DESCRIPTION OF THE DRAWINGS

So that the manner in which the above recited aspects are attained and can be understood in detail, a more particular description of embodiments, briefly summarized above, may be had by reference to the appended drawings. Note, however, that the appended drawings illustrate only typical embodiments of the invention and therefore are not to be considered limiting of its scope, for the invention may admit to other equally effective embodiments.

FIG. 1 illustrates a computing infrastructure, according to one or more embodiments.

FIG. 2 illustrates an example schematic diagram depicting log data and feedback flow associated with a log analysis application, according to one or more embodiments.

FIG. 3 illustrates a method of processing log file data to create mapping results compatible with downstream application tasks, according to one or more embodiments.

FIG. 4 illustrates a method of inducting data into a knowledge base associated with a log comprehension machine learning knowledge model, according to one or more embodiments.

FIG. 5 illustrates a method of updating a knowledge base in accordance with a common log schema, according to one or more embodiments.

FIG. 6 illustrates a method of merging multiple nodes among a plurality of nodes in the context of updating a knowledge base, according to one or more embodiments.

FIG. 7 illustrates a method of extracting a plurality of key-value pairs from a log aggregator dataset in the context of knowledge base data induction, according to one or more embodiments.

FIG. 8 illustrates a method of extracting at least one key-value pair from a log file in the context of downstream log file data processing, according to one or more embodiments.

### DETAILED DESCRIPTION

The various embodiments described herein are directed to inducting data into a knowledge base from log aggregator datasets and comparing log file data with inducted knowledge base data via a log comprehension machine learning knowledge model in order to create mapping results for the log file data compatible with at least one downstream application.

The various embodiments described herein have advantages over conventional techniques. By inducting log data into a knowledge base in order to configure a common log schema, and by updating the knowledge base according to the common log schema, the various embodiments improve computer technology by enhancing log comprehension for downstream application processing. Via application of a log comprehension machine learning knowledge model in the context of comparing data extracted from a received log file with knowledge base node data, the various embodiments improve computer technology by creating mapping results for the log file in order to facilitate log file input handling for at least one downstream application. Through creation of the mapping results, the various embodiments enable formatting key-value pair data of a log file into a canonical form that facilitates key-value pair input data comprehension by the at least one downstream application. Some of the various embodiments may not include all such advantages, and such advantages are not necessarily required of all embodiments.

In the following, reference is made to various embodiments of the invention. However, it should be understood that the invention is not limited to specific described embodiments. Instead, any combination of the following features and elements, whether related to different embodiments or not, is contemplated to implement and practice the invention. Furthermore, although embodiments may achieve advantages over other possible solutions and/or over the prior art, whether or not a particular advantage is achieved by a given embodiment is not limiting. Thus, the following aspects, features, embodiments, and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in one or more claims.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given computer program product claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data typically is moved at some occasional points in time during normal operations of a storage device, such as during access, de-fragmentation, or garbage collection, but this does not render the storage device as transitory because the data is not transitory while it is stored.

Particular embodiments describe techniques relating to log data comprehension. However, it is to be understood that the techniques described herein may be adapted to a variety of purposes in addition to those specifically described herein. Accordingly, references to specific embodiments are included to be illustrative and not limiting.

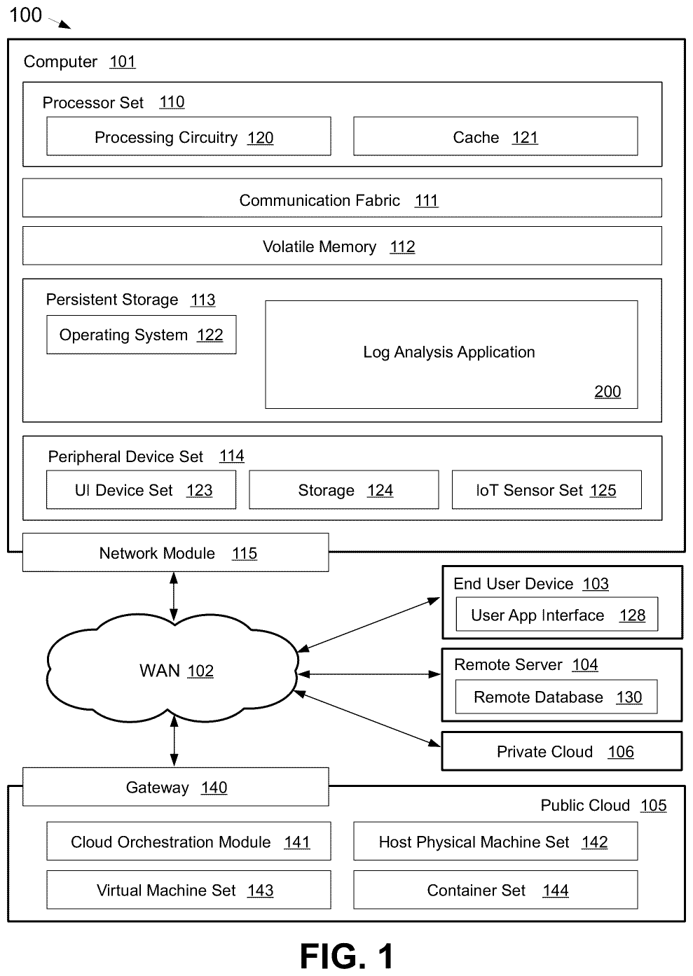

With regard to FIG. 1, computing environment 100 includes an example of an environment for the execution of at least some of the computer code involved in performing the inventive methods, such as code included in or otherwise associated with log analysis application 200. In addition to log analysis application 200, computing environment 100 includes, for example, computer 101, wide area network (WAN) 102, end user device (EUD) 103, remote server 104, public cloud 105, and private cloud 106. In this embodiment, computer 101 includes processor set 110, communication fabric 111, volatile memory 112, persistent storage 113, peripheral device set 114, and network module 115. Processor set 110 includes processing circuitry 120 and cache 121. Persistent storage 113 includes operating system 122 and log analysis application 200, as identified above. Peripheral device set 114 includes user interface (UI) device set 123, storage 124, and Internet of Things (IoT) sensor set 125. EUD 103 includes user application interface 128. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network, or querying a database, such as remote database 130. Computer 101 is included to be representative of a single computer or multiple computers. As is well understood in the art of computer technology, and depending upon the technology, performance of a computer-implemented method may be distributed among multiple computers and/or between multiple locations. As depicted in FIG. 1, detailed discussion is focused on a single computer, specifically computer 101, to keep the presentation of computing environment 100 as simple as possible. Additionally or alternatively to being connectively coupled to public cloud 105 and private cloud 106, computer 101 may be located in a cloud, even though it is not shown in a cloud in FIG. 1. On the other hand, computer 101 is not required to be in a cloud or connectively coupled to a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories typically are organized into multiple levels depending upon relative proximity to the processing circuitry. Alternatively, some, or all, of the cache 121 for processor set 110 may be located “off chip”. In some computing environments, processor set 110 may be designed for working with qubits and performing quantum computing.

Computer readable program instructions typically are loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions and associated data are accessed by processor set 110 to control and direct performance of the inventive methods. In computing environment 100, at least some of the instructions for performing the inventive methods may be stored in log analysis application 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but additionally or alternatively volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and rewriting of data. Some familiar forms of persistent storage include magnetic disks and solid state storage devices. Operating system 122 may take several forms, such as various known proprietary operating systems or open source Portable Operating System Interface-type operating systems that employ a kernel. Log analysis application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the Internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments, e.g., embodiments that utilize software-defined networking (SDN), the control functions and the forwarding functions of network module 115 are performed on physically separate devices, such that the control functions manage several different network hardware devices. Computer readable program instructions for performing the inventive methods typically can be downloaded to computer 101 from an external computer or external storage device through a network adapter card or network interface included in network module 115.

Wide area network (WAN) 102 is any wide area network, e.g., the Internet, capable of communicating computer data over non-local distances by any technology for communicating computer data, now known or to be developed in the future. In some embodiments, WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

End user device (EUD) 103 is any computer system that is used and controlled by an end user, e.g., a customer of an enterprise that operates computer 101. EUD 103 may take any of the forms previously discussed in connection with computer 101. EUD 103 typically receives helpful and useful data from the operations of computer 101. For example, in a hypothetical case where computer 101 is designed to provide a recommendation to an end user, such recommendation typically would be communicated from network module 115 of computer 101 through WAN 102 to EUD 103. In this way, EUD 103 can display, or otherwise present, the recommendation to an end user, e.g., via user application interface 128. In some embodiments, EUD 103 may be a client device, such as thin client, heavy client, mainframe computer, desktop computer, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, such historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. Public cloud 105 optionally offers infrastructure as a service (IaaS), platform as a service (PaaS), software as a service (SaaS), and/or other cloud computing services. The computing resources provided by public cloud 105 typically are implemented by virtual computing environments (VCEs) that run on various computers making up the computers of host physical machine set 142, which is the universe of physical computers in and/or available to public cloud 105. The VCEs typically take the form of virtual machines from virtual machine set 143 and/or containers from container set 144. It is understood that such VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of VCEs will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the perspective of programs running in them. A computer program running on an ordinary operating system can utilize all resources of that computer, such as connected devices, files and folders, network shares, central processing unit (CPU) power, and quantifiable hardware capabilities. However, programs running inside a container only can use the contents of the container and devices assigned to the container, a feature which is known as containerization.

Private cloud 106 is similar to public cloud 105, except that the computing resources only are available for use by a single enterprise. While private cloud 106 is depicted in FIG. 1 as being in communication with WAN 102, in other embodiments a private cloud optionally is disconnected from the Internet or other public network entirely and is accessible only through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 both are part of a larger hybrid cloud.

In the context of the various embodiments described herein, components of computing environment 100, including aspects of log analysis application 200, provide, or are configured to provide, any entity associated with log data comprehension, e.g., any site reliability engineer (SRE) or administrator associated with computer 101 or any user associated with EUD 103 or another aspect of computing environment 100, advance notice of any personal data collection. Components of computing environment 100 further provide, or further are configured to provide, any affected entity an option to opt in or opt out of any such personal data collection at any time. Optionally, components of computing environment 100 further transmit, or further are configured to transmit, notification(s) to any affected entity each time any such personal data collection occurs and/or at designated time intervals.

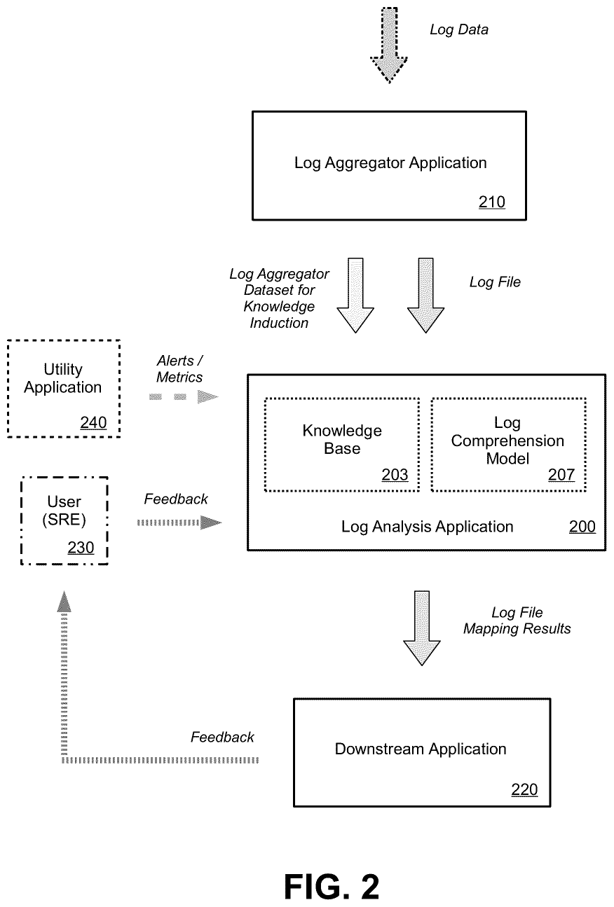

FIG. 2 illustrates an example schematic diagram depicting log data flow and feedback flow associated with log analysis application 200 within computing environment 100. As depicted in FIG. 2, log analysis application 200 includes knowledge base 203 and log comprehension machine learning knowledge model 207. Based upon processing of log data by log aggregator application 210, log analysis application 200 receives either a log aggregator dataset in the context of knowledge base data induction or a log file in the context of downstream log file data processing. Log aggregator application 210 is representative of a single application or multiple applications. In the context of downstream log file data processing, log analysis application 200 creates log file mapping results to transmit to downstream application 220. Downstream application 220 is representative of a single application or multiple applications. Log analysis application 200 receives from utility application 240 metrics or alerts linked to a log aggregator dataset in the context of knowledge base data induction or linked to a log file in the context of downstream log file data processing. Utility application 240 is representative of a single application or multiple applications. A user 230, such as an SRE, provides feedback to log analysis application 200. Such feedback optionally originates directly from user 240 or alternatively is received by user 240 via downstream application 220.

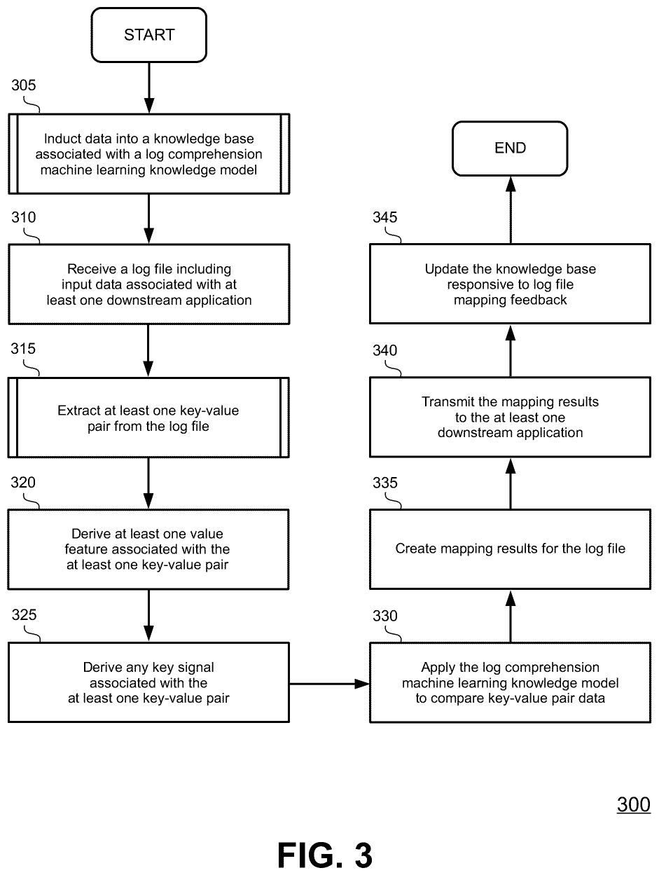

FIG. 3 illustrates a method 300 of processing log file data to create mapping results compatible with downstream application tasks. One or more steps associated with the method 300 and related methods described herein optionally are carried out via a log analysis application in a computing environment (e.g., via log analysis application 200 included in computer 101 of computing environment 100). One or more steps associated with the method 300 and the other methods described herein optionally are carried out within, or in association with, one or more workloads of a cloud computing environment. Such cloud computing environment optionally includes a public cloud (e.g., public cloud 105) and/or a private cloud (e.g., private cloud 106).

The method 300 begins at step 305, where the log analysis application inducts data into a knowledge base (e.g., knowledge base 203) associated with a log comprehension machine learning knowledge model (e.g., log comprehension machine learning knowledge model 207) in order to configure a common log schema. In the context of the various embodiments, a knowledge base is a knowledge graph including nodes representative of respective key-value pairs extracted from log data and edges between the nodes representative of relations between the respective key-value pairs. In an embodiment, the knowledge base optionally is public or alternatively is private, dependent on use objective and/or client. In a related embodiment, the knowledge base incorporates client-specific log information. In a further related embodiment, the knowledge base incorporates publicly accessible log information. In a further related embodiment, the knowledge base incorporates both client-specific log information and publicly accessible log information. In the context of the various embodiments, the log analysis application inducts data into the knowledge base by analyzing data from a plurality of log data sources and importing extracted data aspects of the analyzed data, including key-value pair data, into respective knowledge base nodes. As further described herein, the log analysis application receives log data for induction in a log aggregator dataset. In the context of the various embodiments, a log aggregator dataset is a dataset including consolidated and standardized log data from across a computing environment. A log aggregator dataset includes a collection of text messages and stack traces. In the context of the various embodiments, a log aggregator dataset includes aggregated log data processed by at least one log aggregator application (e.g., log aggregator application 210). In the context of the various embodiments, a log aggregator application is configured to process a stream of logs in order to create a log aggregator dataset.

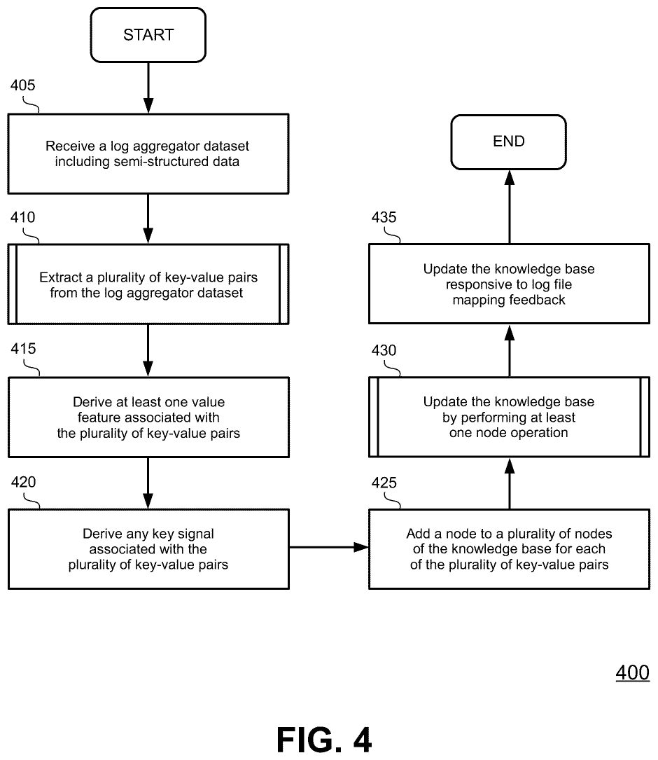

In the context of the various embodiments, the common log schema is a structure through which the log analysis application organizes data inducted into the knowledge base associated with the log comprehension machine learning knowledge model. The log analysis application inducts data into the knowledge base by organizing such data according to the common log schema. Furthermore, the log analysis application updates such data according to the common log schema. As further described herein, the log analysis application builds and updates the knowledge base by creating and organizing nodes in accordance with the common log schema. The common log schema is cumulative such that the log analysis application continuously adds to or modifies the schema consequent to successive knowledge base data induction activities. The log analysis application trains the log comprehension machine learning knowledge model consequent to knowledge base data induction. The log analysis application trains the log comprehension machine learning knowledge model to function in accordance with the common log schema, e.g., by configuring the model to recognize structural organization of the knowledge base. Step 305 is an asynchronous step relative to other steps of the method 300. Accordingly, the log analysis application may induct knowledge base data prior to, concurrently with, or subsequent to execution of one or more other steps of the method 300. A method of inducting data into the knowledge base in accordance with step 305 is described with respect to FIG. 4.

At step 310, the log analysis application receives a log file including input data associated with at least one downstream application (e.g., downstream application 220). In the context of the various embodiments, a log file includes text messages and stack traces. In an embodiment, the log file is associated with one or more of the at least one log aggregator application. In a related embodiment, the log analysis application receives the log file from one of the at least one aggregator application. In an alternative embodiment, the log file is associated with a raw log. In the context of the various embodiments, the at least one downstream application includes one or more applications dependent on or aided by log analysis and knowledge base mapping performed by the log analysis application and optionally related application(s). In an embodiment, the at least one downstream application is, or incorporates aspects of, an anomaly detection application or an incident prediction application. As described in subsequent steps of the method 300, the log analysis application processes the received log file via the log comprehension machine learning knowledge model in order to create mapped results for input to the at least one downstream application.

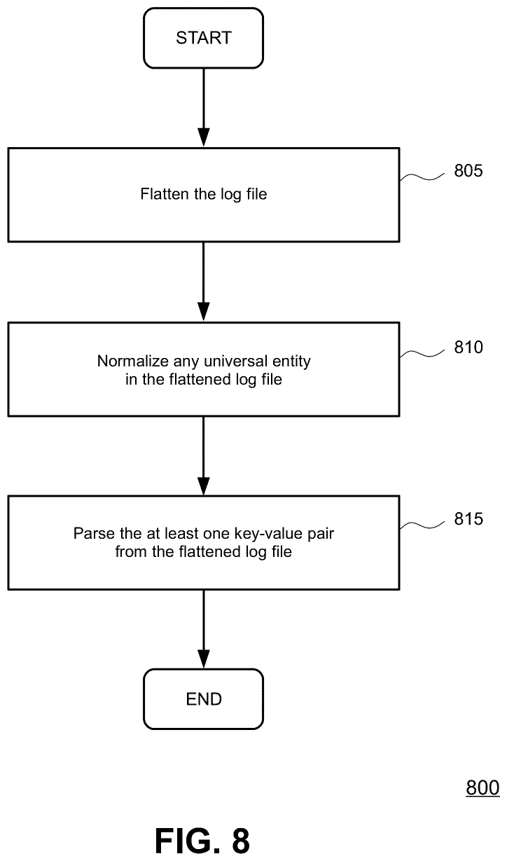

At step 315, the log analysis application extracts at least one key-value pair from the log file. In the context of the various embodiments, a key-value pair is a data representation associating a key element with a value element or a set of multiple value elements. A key-value pair alternatively may be referred to as an attribute-value pair, a field-value pair, or a name-value pair. The log analysis application extracts the at least one key-value pair from the log file per step 315 in order to identify potential portions of the log file for reformatting in accordance with the common log schema of the knowledge base. In an embodiment, as further described herein, the log analysis application flattens the log file, normalizes any universal entity in the flattened log file, and parses the at least one key-value pair from the flattened log file. A method of extracting the at least one key-value pair from the log file in accordance with step 315 is described with respect to FIG. 8.

At step 320, the log analysis application derives at least one value feature associated with the at least one key-value pair extracted from the log file. In an embodiment, the log analysis application derives the at least one value feature associated with the at least one key-value pair by categorizing by value type one or more of the at least one key-value pair. In a related embodiment, value types associated with categorizing a key-value pair among the at least one key-value pair optionally include at least one of a categorical string value type, a non-categorical string value type, a numerical value type, and a date-time value type. In the context of the various embodiments, a categorical string value type, or a categorical variable, is a qualitative value type associated with a limited, and usually fixed, number of possible values. Examples of a categorical string value type include country affiliation or blood type. In the context of the various embodiments, a non-categorical string value type is a string value type unassociated with a limited number of possible values. A non-categorical string value type optionally encompasses a phrase value type or a sentence value type. In the context of the various embodiments, a numerical value type is a value type associated with a number. A numerical value type optionally encompasses an integer value type, an unsigned integer value type, a short integer value type, a long integer value type, a float value type, and a complex number value type. Additionally, a numerical value type optionally encompasses a quantifiable alphanumeric value type. Moreover, a numerical value type optionally encompasses a quantifiable char value type. A date-time value type encompasses value elements indicative of date and/or time. In a further related embodiment, value types associated with categorizing a key-value pair among the at least one key-value pair include a high entropy value type and a low entropy value type, which are indicative of value variation. In the context of the various embodiments, a high entropy value type is a value type that has relatively high variation and is unrepresentable via patterns. A high entropy value type is characterized by relatively low value repetition. A date-time value type generally is a high entropy value type, e.g., a time value in seconds to complete a certain task. In the context of the various embodiments, a low entropy value type is a value type that is representable by a single value or by a small quantity of values, e.g., a file path or a hardware server Internet Protocol address.

In an embodiment, the log analysis application derives the at least one value feature associated with the at least one key-value pair by deriving at least one regular expression associated with the at least one key-value pair. According to such embodiment, the log analysis application derives a regular expression corresponding to one or more value elements of a key-value pair among the at least one key-value pair. In the context of the various embodiments, a regular expression is a search pattern used to match string character combinations. A regular expression standardizes organization of log text patterns and/or log categories by search pattern. Accordingly, a regular expression enables string-searchability of diverse log formats. A regular expression facilitates compact storage and efficient access of value elements (e.g., string values or value categories) corresponding to a particular key. In a related embodiment, the log analysis application represents multiple value elements via a single pattern-based regular expression value element. For instance, in lieu of storing multiple value elements having pattern-based similarities, the log analysis application optionally stores a single regular expression reflective of the pattern-based similarities. In a further related embodiment, the log analysis application automatically generates a regular expression for a key-value pair among the at least one key-value pair by applying a set of rules to at least one value element, e.g., one or more strings and/or one or more value categories, associated with the key-value pair.

In an embodiment, the log analysis application derives the at least one value feature associated with the at least one key-value pair by categorizing data type of a numeric or character value element of a key-value pair among the at least one key-value pair. According to such embodiment, the log analysis application applies at least one categorization algorithm to the value element based upon key type of the key-value pair. In a related embodiment, the log aggregator application categorizes data type of the value element by applying at least one supervised or partially supervised classification algorithm. In a further related embodiment, the log aggregator application categorizes data type of the value element by applying at least one unsupervised clustering algorithm.

At step 325, the log analysis application derives any key signal associated with the at least one key-value pair extracted from the log file. In the context of the various embodiments, a key signal is a predefined attribute that serves as an informative aspect (e.g., a cue or a warning) related to the at least one downstream application. In the context of the various embodiments, a key signal is reflective of an issue or a datapoint related to one or more of the at least one downstream application. For instance, a key signal may indicate a warning associated with a downstream application task. In an embodiment, the log analysis application derives a key signal associated with a key-value pair (or multiple key-value pairs) among the at least one key-value pair. In a related embodiment, the log analysis application derives a key signal for a key-value pair (or multiple key-value pairs) by analyzing at least one value element of the key-value pair (or the multiple key-value pairs), e.g., by processing one or more string values. In a further related embodiment, the log analysis application derives a key signal from a key-value pair (or multiple key-value pairs) by applying at least one natural language processing (NLP) technique. In a further related embodiment, the log analysis application derives a key signal from a key-value pair (or multiple key-value pairs) by applying at least one machine learning technique, e.g. at least one data categorization algorithm such as a classification algorithm or a clustering algorithm.

In an embodiment, a key signal derived by the log analysis application from a key-value pair includes at least one symptom of an application issue associated with the key-value pair. In a related embodiment, the log analysis application derives a symptom by processing grammatical portions of any string value of a key-value pair indicative of a symptom. Such string value may be of a non-categorical value type, e.g., a phrase or a sentence. According to such related embodiment, the log analysis application optionally applies at least one NLP technique in order to extract from a string value at least one triplet (subject-verb-object) and/or at least one non-overlapping pair (subject-verb, verb-object) and construct a symptom phrase based upon the at least one triplet and/or the at least one non-overlapping pair. In an additional embodiment, a key signal derived by the log analysis application from a key-value pair includes at least one cause of an application issue associated with the key-value pair. The at least one cause key signal optionally is tied to at least one symptom key signal. In a related embodiment, the log analysis application derives a cause by processing grammatical portions of any string value of a key-value pair indicative of a cause. Such string value may be of a non-categorical value type, e.g., a phrase or a sentence. According to such related embodiment, the log analysis application optionally applies at least one NLP technique in order to extract at least one grammatical aspect indicative of a cause and construct a cause phrase based upon such at least one grammatical aspect. Grammatical aspects indicative of a cause include simple causative verbs, phrasal verbs consisting of a verb followed by a grammatical particle, a noun indicative of a cause followed by a preposition, and passive causal verbs followed by the preposition “by” (e.g., “caused by”, “triggered by”, etc.).

In a further embodiment, a key signal derived by the log analysis application from a key-value pair includes a golden signal metric reflective of an application issue or an application datapoint. In the context of the various embodiments, golden signal metrics include application request error rate, application resource saturation, application traffic, and application request latency. According to such further embodiment, the log analysis application identifies at least one seed word associated with each of the golden signal metrics and compares the at least one seed word to any token within at least one value element of the key-value pair. A token in such context is a word or group of words that constitutes a potential match to one of the at least one seed word. According to such further embodiment, the log analysis application optionally derives at least one error code associated with an error-based golden signal. According to such further embodiment, the log analysis application stores any fault type correlation associated with multiple error-based golden signals.

In a further embodiment, a key signal derived by the log analysis application from a key-value pair includes a statistical metric type associated with the key-value pair in relation to downstream application tasks. In a related embodiment, a statistical metric type is one of a histogram, a counter, a gauge, or a dimension. The log analysis application determines a statistical metric type based upon statistical variation of value elements associated with the key element of the key-value pair. In a further related embodiment, the log analysis application prioritizes key-value pairs based upon statistical metric type. In a related embodiment, the log analysis application prioritizes key-value pairs associated with a histogram or counter statistical metric type over key-value pairs associated with a gauge or dimension statistical metric type. Such prioritization optionally facilitates determination of relevant key-value pairs for input processing associated with the at least one downstream application.

In an embodiment, the log analysis application derives a key signal for a key-value pair among the at least one key-value pair at least in part based upon metrics or alerts linked to the log file originating from at least one utility application (e.g., utility application 240) configured to generate metrics or alerts based upon log analysis. In an additional embodiment, the log analysis application derives a key signal common to multiple key-value pairs among the at least one key-value pair.

At step 330, the log analysis application applies the log comprehension machine learning knowledge model in order to compare data associated with the at least one key-value pair extracted from the log file with knowledge base node key-value pair data. In an embodiment, the log analysis application applies, via the log comprehension machine learning knowledge model, at least one algorithm to the at least one extracted key-value pair from the log file in order to compare the at least one extracted key-value pair with knowledge base node key-value pair data. In a related embodiment, the log analysis application iteratively compares each key-value pair among the at least one key-value pair extracted from the log file with each key-value pair associated with a knowledge base node.

In an embodiment, the log analysis application determines the at least one algorithm for comparison per step 330 at least in part based upon the at least one value feature derived for the at least one extracted key-value pair. In a related embodiment, the log analysis application determines the at least one algorithm for comparison at least in part based upon value-type categorization of the at least one extracted key-value pair. According to such related embodiment, the log analysis application optionally applies at least one string matching algorithm or at least one pattern matching algorithm to compare one or more extracted key-value pairs of a categorical string type with knowledge base node key-value pair data of a categorical string type. According to such related embodiment, the log analysis application optionally applies at least one string matching algorithm or at least one pattern matching algorithm to compare one or more extracted key-value pairs of a non-categorical string type (e.g., phrase type) with knowledge base node key-value pair data of a non-categorical string type. According to such related embodiment, the log analysis application optionally applies distribution based patching, e.g., via utilization of at least one diff file, to compare one or more extracted key-value pairs of a numerical type with key-value pair knowledge base node data of a numerical type.

In an embodiment, the log analysis application determines at least one algorithm for comparison per step 330 at least in part based upon at least one regular expression derived for the at least one extracted key-value pair. According to such embodiment, the log analysis application optionally applies at least one pattern matching algorithm to compare the at least one regular expression derived for the at least one extracted key-value pair with any regular expression derived for knowledge base node key-value pair data. In a related embodiment, the log analysis application iteratively compares at least one regular expression derived for each key-value pair among the at least one key-value pair extracted from the log file with any regular expression derived for each knowledge base node key-value pair. In a further embodiment, the log analysis application applies the log comprehension machine learning knowledge model according to step 330 in order to compare any key signal derived for the at least one extracted key-value pair with any key signal derived for knowledge base node key-value pair data. In a related embodiment, the log analysis application iteratively compares any key signal derived for each key-value pair among the at least one key-value pair extracted from the log file with any key signal derived for each knowledge base node key-value pair.

In an embodiment, the log analysis application determines a key-value pair comparison score with respect to each attempted match between a key-value pair extracted from the log file and a knowledge base node key-value pair. In a related embodiment, the log analysis application incorporates into the key-value pair comparison score any regular expression comparison score determined based upon regular expression matching between the extracted key-value pair and the knowledge base node key-value pair. In a further related embodiment, the log analysis application incorporates into the key-value pair comparison score any key signal comparison score determined based upon key signal matching between the extracted key-value pair and the knowledge base node key-value pair. The log analysis application determines a corresponding knowledge base node key-value pair that most closely resembles the extracted key-value pair based upon highest relative key-value pair comparison score.

In an embodiment, the log analysis application determines a cumulative key-value pair comparison score for a key-value pair extracted from the log file and key-value pair data associated with a knowledge base node by collating all key-value pair comparison scores determined for all attempted matches between the extracted key-value pair and any key-value pair associated with the knowledge base node. In a related embodiment, the log analysis application incorporates into the cumulative key-value pair comparison score any regular expression comparison score determined based upon regular expression matching between the extracted key-value pair and the knowledge base node key-value pair data. In a further related embodiment, the log analysis application incorporates into the cumulative key-value pair comparison score any key signal comparison score determined based upon key signal matching between the extracted key-value pair and the knowledge base node key-value pair data. Based upon highest relative cumulative key-value pair comparison score, the log analysis application optionally determines for the extracted key-value pair corresponding key-value pair data associated with a knowledge base node overall in addition to or alternatively to determining a corresponding knowledge base node key-value pair based upon highest relative key-value pair comparison score.

In an embodiment, based upon the model comparison, the log analysis application maps each key-value pair among the at least one key-value pair extracted from the log file to a corresponding knowledge base node key-value pair. Based upon the model comparison, the log analysis application maps log file aspects to log aspects stored in a corresponding knowledge base node in order to adapt the log file aspects in accordance with the common log schema to a canonical form that is compatible with the at least one downstream application. In a related embodiment, the log analysis application determines a mapping between a key-value pair extracted from the log file and a corresponding knowledge base node key-value pair based upon a highest relative key-value pair comparison score determined responsive to each attempted match between the extracted key-value pair and a knowledge base key-value pair, i.e., a highest comparison score relative to all other determined comparison scores. In an additional related embodiment, the log analysis application determines a mapping between a key-value pair extracted from the log file and corresponding key-value pair data associated with a knowledge base node based upon a highest relative cumulative key-value pair comparison score determined responsive to all attempted matches between the extracted key-value pair and any key-value pair associated with the knowledge base node, i.e., a highest cumulative comparison score relative to all other determined cumulative comparison scores. Mapping according to the aforementioned related embodiments optionally accounts for any derived regular expressions and/or key signals.

At step 335, based upon the model application per step 330, the log analysis application creates mapping results for the log file. The mapping results created per step 335 are formatted according to the common log schema and compatible with the at least one downstream application. According to step 335, the log analysis application creates the mapping results representing data of the log file in the canonical form compatible with the at least one downstream application. By creating the mapping results based upon processing key-value pair aspects of the log file, the log analysis application formats log file aspects in accordance with the common log schema into the canonical form compatible with the at least one downstream application. Through model application, the log analysis application maps relevant key-value aspects of the log file informative to each of the at least one downstream application to corresponding knowledge base node key-value aspects and formats such relevant key-value aspects of the log file according to the common log schema into the mapping results in the canonical form. By formatting the relevant key-value aspects of the log file into the canonical form compatible with the at least one downstream application, the log analysis application facilitates downstream application input processing. Formatting relevant key-value aspects of the log file into the canonical form facilitates efficient downstream application processing in terms of time and/or storage. In an embodiment, the canonical form into which the log analysis application formats the mapping results is standard with respect to each of the at least one downstream application.

In an embodiment, the log analysis application includes in the mapping results relevant portions of the log file of relatively higher informative value to the at least one downstream application while filtering (i.e., excluding) irrelevant portions of the log file of relatively lower informative value. The informative portions included in the mapping results are dependent upon the respective requirements of each of the at least one downstream application. In a related embodiment, the log analysis application creates mapping results that reflect mappings of relevant key-value pairs extracted from the log file to corresponding key-value pairs associated with respective knowledge base nodes. In a further related embodiment, the log analysis application determines relevance of a key-value pair extracted from the log file based upon a relevancy score calculated for a corresponding knowledge base node key-value pair or calculated for corresponding key-value pair data associated with a knowledge base node overall. According to such related embodiment, the log analysis application includes in the mapping results any key-value pair extracted from the log file corresponding to a knowledge base node key-value pair or corresponding to knowledge base node key-value pair data having a relevancy score exceeding a predetermined relevancy threshold. The predetermined relevancy threshold optionally is set by one or more of the at least one downstream application or alternatively is set by a user associated with the log analysis application.

The log analysis application includes in the mapping results a set of key-value pairs of the log file in the canonical form in accordance with the common log schema. In an embodiment, the log analysis application includes within the set only key-value pair(s) compliant with the predetermined relevancy threshold. In an additional embodiment, the log analysis application incorporates into the set any value feature and any key signal derived from the respective key-value pairs within the set for evaluation by the at least one downstream application. In a related embodiment, the log analysis application incorporates into the set explicit text indicating at least one key signal derived from one or more of the respective key-value pairs within the set, e.g., text related to a cause and a symptom associated with a downstream application issue. Additionally or alternatively, the log analysis application incorporates into the set a key signal code representing at least one key signal derived from one or more of the respective key-value pairs within the set, e.g., a particular key signal code may be included for a certain golden signal along with relevant information from the log file.

At step 340, the log analysis application transmits the mapping results to the at least one downstream application. In an embodiment, the log analysis application transmits the mapping results directly to the at least one downstream application. In a related embodiment, the log analysis application inputs the mapping results directly to the at least one downstream application. Additionally or alternatively, the log analysis application transmits the mapping results to at least one user application interface associated with the log analysis application (e.g., user application interface 128). The at least one user application interface optionally is associated with at least one user in the computing environment accessing the at least one downstream application and/or accessing another application communicatively or operatively coupled to the at least one downstream application. Optionally, the at least one user application interface is associated with an end user device communicably coupled to the adaptation application (e.g., EUD 103) via a network (e.g., WAN 102). The at least one user application interface includes a graphical user interface (GUI), a command line interface (CLI), and/or a sensory interface configured to discern and process user sound/voice commands and/or user gestures.

At step 345, the log analysis application updates the knowledge base responsive to log file mapping feedback associated with the at least one downstream application. Step 345 may be optional in certain contexts, because execution is contingent upon receipt of log file mapping feedback. In an embodiment, the log file mapping feedback originates from the at least one downstream application. According to such embodiment, the log file mapping feedback originating from the at least one downstream application is transmitted to a user (e.g., user 230) in order to modify one or more algorithmic processes associated with knowledge base application in the context of downstream log file data processing, including updating a knowledge base node pruning process to filter irrelevant key-value pairs and/or updating key signal derivation processes, e.g., with respect to golden signal metric derivation or statistical metric derivation. In a related embodiment, the user to which the log file mapping feedback is transmitted is one of an SRE, a code developer, or a file system administrator. Additionally or alternatively, the log analysis application receives the log file mapping feedback associated with the at least one downstream application directly from the aforementioned user, or directly from at least one other user of the at least one downstream application, via the at least one user application interface associated with the log analysis application.

In an embodiment, the log file mapping feedback associated with the at least one downstream application includes evaluation of key signals in the mapping results. In a related embodiment, the evaluation includes a summary of key signals mishandled during log file processing due to low correlation between relevancy scores calculated by the log analysis application for respective key-value pairs in the knowledge base and downstream relevancy metrics. The evaluation optionally includes a summary of key signals excluded from the mapping results of relatively high relevance to the at least one downstream application, e.g., a listing of key signals excluded from the mapping results that are associated with knowledge base node key-value pairs having respective relevancy scores not exceeding the predetermined relevancy threshold but exceeding downstream relevancy metrics. The evaluation optionally includes a summary of key signals included in the mapping results of relatively low relevance or of no relevance to the at least one downstream application, e.g., a listing of key signals included in the mapping results that are associated with knowledge base node key-value pairs having respective relevancy scores exceeding the predetermined relevancy threshold but not exceeding downstream relevancy metrics. In a further related embodiment, the log analysis application automatically updates key signal aspects of the knowledge base based upon the feedback in order to calibrate the relevancy scores of respective key-value pairs associated with key signals included in the summary such that the relevancy scores more closely match downstream relevancy metrics.

FIG. 4 illustrates a method 400 of inducting data into the knowledge base. The method 400 provides one or more embodiments with respect to step 305 of the method 300. The method 400 begins at step 405, where the log analysis application receives a log aggregator dataset including semi-structured data. In the context of the various embodiments, semi-structured data includes both structured data and unstructured data. In an embodiment, the log analysis application handles the structured data and the unstructured data separately. In an additional embodiment, the log analysis application receives the log aggregator dataset from one of the at least one log aggregator application. In a further embodiment, the log aggregator dataset includes aggregated information derived from a set of logs. In a further embodiment, the set of logs includes a plurality of heterogeneous logs. By building the knowledge base based upon the log aggregator dataset, the log analysis application analyzes a stream of logs rather than a single log during model-based processing of a log file according to the method 300.

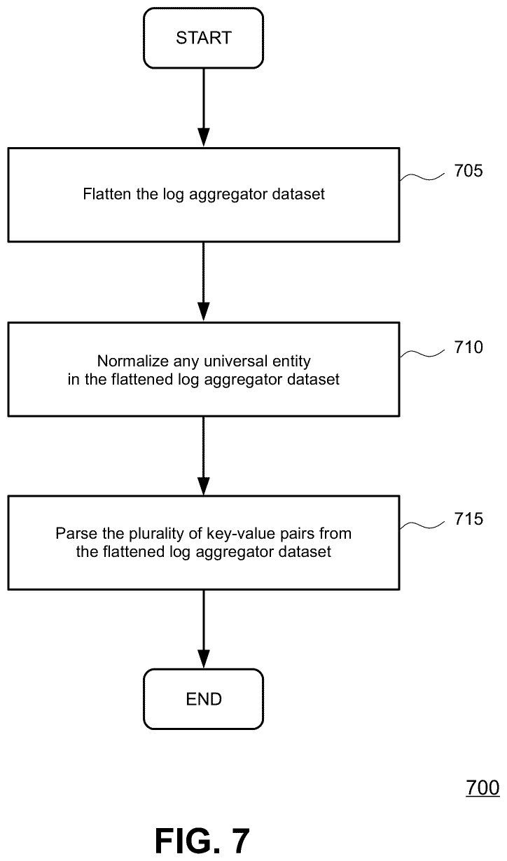

At step 410, the log analysis application extracts a plurality of key-value pairs from the log aggregator dataset. In an embodiment, as further described herein, the log analysis application flattens the log aggregator dataset, normalizes any universal entity within the log aggregator dataset, and parses the plurality of key-value pairs from the flattened log aggregator dataset. A method of extracting the plurality of key-value pairs from the log aggregator dataset in accordance with step 410 is described with respect to FIG. 7.

At step 415, the log analysis application derives at least one value feature associated with the plurality of key-value pairs extracted from the log aggregator dataset. In an embodiment, the log analysis application derives the at least one value feature associated with the plurality of key-value pairs by categorizing by value type one or more of the plurality of key-value pairs. In a related embodiment, value types associated with categorizing a key-value pair among the plurality of key-value pairs include at least one of a categorical string value type, a non-categorical string value type, a numerical value type, and a date-time value type. In a further related embodiment, value types associated with categorizing a key-value pair among the plurality of key-value pairs include a high entropy value type and a low entropy value type, which are indicative of value variation. Details regarding such value types, previously described with respect to step 320, are applicable with respect to value feature derivation per step 415.

In an embodiment, the log analysis application derives the at least one value feature associated with the plurality of key-value pairs by deriving at least one regular expression associated with the plurality of key-value pairs. According to such embodiment, the log analysis application derives a regular expression corresponding to one or more value elements of a key-value pair among the plurality of key-value pairs. In a related embodiment, the log analysis application represents multiple value elements via a single pattern-based regular expression value element. In a further related embodiment, the log analysis application automatically generates a regular expression for a key-value pair among the plurality of key-value pairs by applying a set of rules to at least one value element associated with the key-value pair.

In an embodiment, the log analysis application derives the at least one value feature associated with the plurality of key-value pairs by categorizing data type of a numeric or character value element of a key-value pair among the plurality of key-value pairs. According to such embodiment, the log analysis application applies at least one categorization algorithm to the value element based upon key type of the key-value pair. In a related embodiment, the log aggregator application categorizes data type of the value element by applying at least one supervised or partially supervised classification algorithm. In a further related embodiment, the log aggregator application categorizes data type of the value element by applying at least one unsupervised clustering algorithm.

At step 420, the log analysis application derives any key signal associated with the plurality of key-value pairs extracted from the log aggregator dataset. In an embodiment, the log analysis application derives a key signal associated with a key-value pair (or multiple key-value pairs) among the plurality of key-value pairs. In a related embodiment, the log analysis application derives a key signal for a key-value pair (or multiple key-value pairs) by analyzing at least one value element of the key-value pair (or the multiple key-value pairs), e.g., by processing one or more string values. In a further related embodiment, the log analysis application derives a key signal from a key-value pair (or multiple key-value pairs) by applying at least one NLP technique. In a further related embodiment, the log analysis application derives a key signal from a key-value pair (or multiple key-value pairs) by applying at least one machine learning technique, e.g. at least one data categorization algorithm such as a classification algorithm or a clustering algorithm.

According to one or more embodiments, the log analysis application derives one or more key signals for one or more of the plurality of key-value pairs in accordance with techniques previously described with respect to step 325. Such key signals optionally include one or more of the following: at least one symptom of an application issue associated with the key-value pair, at least one cause of an application issue associated with the key-value pair, a golden signal metric reflective of an application issue or an application datapoint, and a statistical metric type associated with the key-value pair in relation to downstream application tasks. In a further embodiment, the log analysis application derives a key signal for one or more of the plurality of key-value pairs at least in part based upon metrics or alerts linked to the log aggregator dataset originating from the at least one utility application. In a further embodiment, the log analysis application derives a key signal common to multiple key-value pairs among the plurality of key-value pairs.

At step 425, the log analysis application adds a node to a plurality of nodes of the knowledge base for each of the plurality of key-value pairs. In an embodiment, the log analysis application adds a node for a respective key-value pair including a key element, at least one value element, the at least one derived value feature, and any derived key signal. In an additional embodiment, a node for a respective key-value pair includes relation information with respect to key-value aspects of one or more other knowledge base nodes. The relation information of a node describes any logical relationship or any other connection between the key-value pair of the node and one or more other key-value pairs of other knowledge base nodes. In a related embodiment, the log analysis application extracts relation information from log text, e.g., a relation name, by applying at least one NLP technique. In a further related embodiment, the log analysis application extracts relation information from log text by applying at least one machine learning technique, e.g., at least one data categorization algorithm. In a further embodiment, the log analysis application builds one or more edges between two or more nodes among the plurality of nodes based upon relation information. According to such further embodiment, an edge between nodes signifies one or more logical relationships or connections between respective key-value pairs of the nodes. The log analysis application adds and configures a node for a respective key-value pair per step 425 in accordance with the common log schema and furthermore adapts the common log schema to reflect any relation information associated with the node.

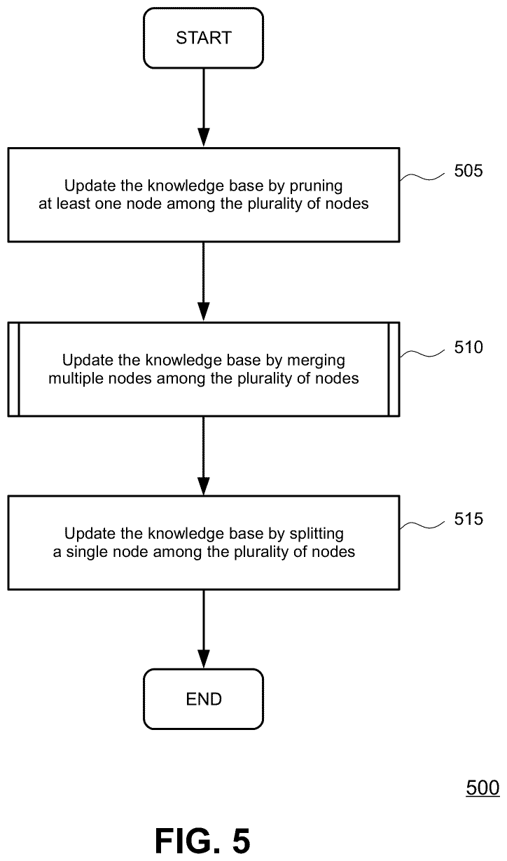

At step 430, the log analysis application updates the knowledge base in accordance with the common log schema. The log analysis application updates the knowledge base per step 430 by performing at least one operation upon the plurality of nodes. In an embodiment, the at least one operation includes pruning at least one node among the plurality of nodes. In an additional embodiment, the at least one operation includes merging multiple nodes among the plurality of nodes. In a further embodiment, the at least one operation includes splitting a single node among the plurality of nodes. Embodiments with respect to performing a pruning operation, a merge operation, and a split operation are described further herein. A method of updating the knowledge base in accordance with the common log schema according to step 430 is described with respect to FIG. 5.

At step 435, the log analysis application updates the knowledge base responsive to user feedback. Step 435 may be optional in certain contexts, because execution is contingent upon receipt of user feedback. In an embodiment, the log analysis application receives the user feedback via the at least one user application interface. In an additional embodiment, the log analysis application receives the user feedback from an SRE. In a further embodiment, the log analysis application receives the user feedback from the at least one user with regard to activity associated with the at least one downstream application. In a further embodiment, the user feedback is directed to modifying one or more algorithmic processes associated with knowledge base data induction, including updating a knowledge base node pruning process to filter irrelevant key-value pairs and/or updating key signal derivation processes, e.g., with respect to golden signal metric derivation or statistical metric derivation. Based upon the user feedback, the log analysis application optionally updates at least one algorithm associated with key signal derivation, e.g., golden signal detection.

Optionally, the log analysis application repeats one of more steps of the method 300 and/or one or more steps of the method 400 in order to address any further received log aggregator dataset in the context of knowledge base data induction and/or in order to address any further received log file in the context of downstream log file data processing.

FIG. 5 illustrates a method 500 of updating the knowledge base in accordance with the common log schema. The method 500 provides one or more embodiments with respect to step 430 of the method 400. The method 500 begins at step 505, where the log analysis application updates the knowledge base by pruning at least one node among the plurality of nodes. According to step 505, the log analysis application prunes a node consequent to filtering, i.e., excluding from knowledge base consideration, a key-value pair associated with the node. In an embodiment, the log analysis application marks such filtered key-value pair as irrelevant and optionally stores an irrelevancy value element associated therewith in a data structure configured to track irrelevant key-value pairs. In an embodiment, the log analysis application identifies a key-value pair as irrelevant and prunes a node associated with the key-value pair based upon absence of such key-value pair in log information of a collection of historical resolved tickets associated with the at least one downstream application. Such absence indicates relatively low key-value pair relevance in the context of downstream relevancy metrics. In an additional embodiment, the log analysis application prunes a node associated with a key-value pair having a relevancy score that does not exceed the predetermined relevancy threshold. In a further embodiment, the log analysis application prunes at least one node among the plurality of nodes based upon domain knowledge provided by or otherwise associated with an SRE.

In an embodiment, per step 505 the log analysis application prunes at least one node among the plurality of nodes associated with a key-value pair having a value element of a high entropy value type, exclusive of high entropy non-categorical string value types. While many value elements associated with a non-categorical string value type are high entropy, the log analysis application preserves key-value pairs having such value elements. According to such further embodiment, the log analysis application filters any key-value pair having a value element of a high entropy categorical string value type, a high entropy numerical value type, or a high entropy date-time value type. The log analysis application may filter a high percentage of key-value pairs having a value element of a date-time value type, since a high percentage of date-time values are inherently high entropy due to the nonrepetitive nature of dates. In an additional embodiment, the log analysis application prunes at least one node among the plurality of nodes associated with a key-value pair having a value element of a low entropy value type responsive to determining that the key-value pair is not associated with any derived key signal. Additionally or alternatively, the log analysis application prunes at least one node among the plurality of nodes associated with a key-value pair having a value element of a low entropy value type responsive to determining that the knowledge base exceeds a predetermined storage capacity. In a further embodiment, the log analysis application reevaluates any key-value pair associated with a pruned node to derive any undiscovered key signal according to step 420.

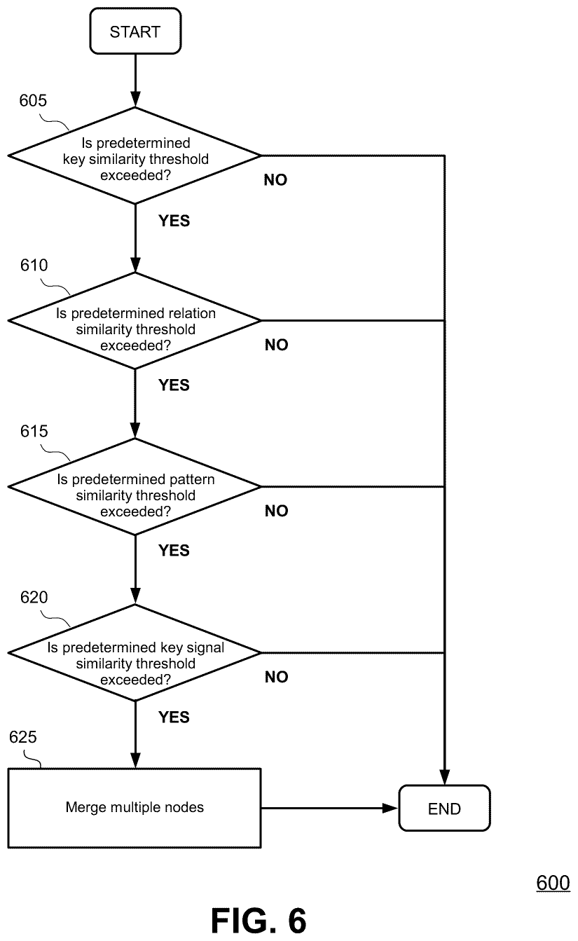

At step 510, the log analysis application updates the knowledge base by merging multiple nodes among the plurality of nodes. Optionally, the log analysis application performs a merge operation upon two nodes. Alternatively, the log analysis application performs a merge operation on three or more nodes. In an embodiment, the log analysis application performs an operation upon the at least one existing node by merging multiple nodes. In an embodiment, the log analysis application combines multiple sets of respective value elements from the multiple nodes into a single set of respective value elements. In a related embodiment, the log analysis application combines multiple pattern value elements by applying at least one pattern matching algorithm. In a further related embodiment, the log analysis application combines multiple string value elements by applying at least one string merging algorithm. A method of merging multiple nodes among the plurality of nodes in accordance with step 510 is described with respect to FIG. 6.

At step 515, the log analysis application updates the knowledge base by splitting a single node among the plurality of nodes. In an embodiment, the log analysis application performs a split operation upon a single node responsive to determining that a previous merge operation associated with two or more nodes resulting in the single node is erroneous consequent to analysis of log information received post-merger that reveals at least one fallacy associated with the previous merge operation. For instance, given that the log analysis application merged nodes A and B based upon receipt of log files having key-value pair information associated with nodes A and B, the log analysis application may determine such node merger to be erroneous in view of subsequent log file information that reveals one or more fallacies associated with such node merger. According to such embodiment, the log analysis application splits the single node to ensure consistency with the log information received post-merger.

According to one or more embodiments, the log analysis application executes the steps of the method 500 in any order and/or in any combination. The log analysis application optionally omits execution of one or more steps of the method 500. In an embodiment, the log analysis application executes step 505 but does not execute steps 510 or 515. In an additional embodiment, the log analysis application executes steps 505-510 but does not execute step 515. In a further embodiment, the log analysis application executes steps 505 and 515 but does not execute step 510. In a further embodiment, the log analysis application executes step 510 but does not execute steps 505 or 515. In a further embodiment, the log analysis application executes step 515 but does not execute steps 505 or 510. In a further embodiment, the log analysis application executes steps 510-515 but does not execute step 505.

FIG. 6 illustrates a method 600 of merging multiple nodes among the plurality of nodes in the context of updating the knowledge base. The method 600 provides one or more embodiments with respect to step 510 of the method 500. The method 600 begins at step 605, where the log analysis application determines whether names of respective key elements of each of the multiple nodes have a semantic meaning exceeding a predetermined key similarity threshold. In an embodiment, the log analysis application determines whether names of respective key elements of each of the multiple nodes have a same semantic meaning via application of at least one NLP algorithm, e.g., to obtain word embedding representations of the respective key elements. Responsive to determining that names of respective key elements of each of the multiple nodes do not have a semantic meaning exceeding the predetermined key similarity threshold, the log analysis application proceeds directly to the end of the method 600 without merging the multiple nodes. Responsive to determining that names of respective key elements of each of the multiple nodes have a semantic meaning exceeding the predetermined key similarity threshold, at step 610 the log analysis application determines whether respective relations of each of the multiple nodes have a semantic meaning exceeding a predetermined relation similarity threshold. In an embodiment, the log analysis application compares relations associated with each of the multiple nodes. In an additional embodiment, the log analysis application compares respective edges from each of the multiple nodes to other nodes to determine similarity of relationships between each of the multiple nodes and the other nodes. In a further embodiment, the log analysis application applies at least one graph algorithm to traverse edges associated with each of the multiple nodes in order to determine similarity of relationships between each of the multiple nodes and the other nodes. Responsive to determining that respective relations of each of the multiple nodes do not have a semantic meaning exceeding the predetermined relation similarity threshold, the log analysis application proceeds directly to the end of the method 600 without merging the multiple nodes.

Responsive to determining that respective relations of each of the multiple nodes have a semantic meaning exceeding the predetermined relation similarity threshold, at step 615 the log analysis application determines whether a level of pattern similarity among respective patterns of value elements associated with each of the multiple nodes exceeds a predetermined pattern similarity threshold. In an embodiment, the log analysis application applies at least one pattern matching algorithm to determine the level of pattern similarity. According to such embodiment, the log analysis application equates a relatively higher level of pattern similarity between or among value elements of each of the multiple nodes to a relatively higher similarity of semantic meaning between or among value elements of each of the multiple nodes. Responsive to determining that the level of pattern similarity among respective patterns of the value elements associated with each of the multiple nodes does not exceed the predetermined pattern similarity threshold, the log analysis application proceeds directly to the end of the method 600 without merging the multiple nodes. Responsive to determining that the level of pattern similarity among respective patterns of the value elements associated with each of the multiple nodes exceeds the predetermined pattern similarity threshold, at step 620 the log analysis application determines whether a level of key signal similarity of derived key signals associated with each of the multiple nodes exceeds a predetermined key signal similarity threshold. In an embodiment, the log analysis application determines the level of key signal similarity at least in part based upon comparison of golden signal metric types associated with each of the multiple nodes. In an additional embodiment, the log analysis application determines the level of key signal similarity at least in part based upon comparison of statistical metric types associated with each of the multiple nodes. Responsive to determining that the level of key signal similarity of derived key signals associated with each of the multiple nodes does not exceed the predetermined key signal similarity threshold, the log analysis application proceeds directly to the end of the method 600 without merging the multiple nodes. Responsive to determining that the level of key signal similarity of derived key signals associated with each of the multiple nodes exceeds the predetermined key signal similarity threshold, at step 625 the log analysis application merges the multiple nodes. According to one or more embodiments, the log analysis application executes only a subset of steps 605-620 in order to determine whether to merge the multiple nodes. Per such one or more embodiments, the log analysis application determines whether to merge the multiple nodes based upon determining that a subset of the thresholds described in steps 605-620 have been exceeded.

FIG. 7 illustrates a method 700 of extracting the plurality of key-value pairs from the log aggregator dataset in the context of inducting data into the knowledge base. The method 700 provides one or more embodiments with respect to step 410 of the method 400. The method 700 begins at step 705, where the log analysis application flattens the log aggregator dataset. In an embodiment, flattening the log aggregator dataset includes removing nesting among data interchange format structures in text of the log aggregator dataset. Such data interchange format structures optionally include at least one of JavaScript Object Notation (JSON) structures, Extensible Markup Language (XML) structures, and Plain Old Java Object (POJO) structures. At step 710, the log analysis application normalizes any universal entity in the flattened log aggregator dataset. In the context of the various embodiments, a universal entity is an entity having a uniform pattern universally, i.e., having a fixed path regardless of log or domain. Examples of universal entities include a date-time entity, a URL, and a file name, and a file path. In an embodiment, the log analysis application normalizes a universal entity in the log aggregator dataset by standardizing the universal entity from representation in diverse formats to representation in a single defined format. For instance, given that a date-time entity may be represented in diverse formats, the log analysis application may standardize a data-time entity to a single defined format. At step 715, the log analysis application parses the plurality of key-value pairs from the flattened log aggregator dataset. In an embodiment, the log analysis application parses a key-value pair among the plurality of key-value pairs by identifying the key-value pair within the log aggregator dataset and separating the key-value pair from other aspects of the log aggregator dataset, e.g., by storing the separated key-value pair as an individual entity within a data structure. In a further embodiment, the log analysis application parses a key-value pair among the plurality of key-value pairs by applying at least one NLP technique. Additionally or alternatively, the log analysis application parses a key-value pair by applying at least one string matching algorithm.

FIG. 8 illustrates a method 800 of extracting the at least one key-value pair from the log file in the context of processing log file data to create mapping results compatible with downstream application tasks. The method 800 provides one or more embodiments with respect to step 315 of the method 300. The method 800 begins at step 805, where the log analysis application flattens the log file. In an embodiment, flattening the log file includes removing nesting among data interchange format structures in text of the log file. At step 810, the log analysis application normalizes any universal entity in the flattened log file. In an embodiment, the log analysis application normalizes a universal entity in the log file by standardizing the universal entity from representation in diverse formats to representation in a single defined format. At step 815, the log analysis application parses the at least one key-value pair from the flattened log file. In an embodiment, the log analysis application parses a key-value pair among the at least one key-value pair by identifying the key-value pair within the log file and separating the key-value pair from other aspects of the log file, e.g., by storing the separated key-value pair as an individual entity within a data structure. In a further embodiment, the log analysis application parses a key-value pair among the at least one key-value pair by applying at least one NLP technique. Additionally or alternatively, the log analysis application parses a key-value pair by applying at least one string matching algorithm.

The descriptions of the various embodiments have been presented for purposes of illustration but are not intended to be exhaustive or limited to the embodiments disclosed. All kinds of modifications made to the described embodiments and equivalent arrangements should fall within the protected scope of the various embodiments. Hence, the scope should be explained most widely according to the claims that follow in connection with the detailed description and should cover all possibly equivalent variations and equivalent arrangements. Many modifications and variations will be apparent to those of ordinary skill in the art without departing from the scope and spirit of the described embodiments. The terminology used herein is chosen to best explain the principles of the various embodiments, the practical application or technical improvement over technologies found in the marketplace, or to enable others of ordinary skill in the art to understand the various embodiments.

What is claimed is:

1. A computer-implemented log comprehension method comprising:
inducting data into a knowledge base associated with a log comprehension machine learning knowledge model in order to configure a common log schema;
extracting at least one key-value pair from a log file including input data associated with at least one downstream application;
deriving at least one value feature associated with the at least one key-value pair;
deriving any key signal associated with the at least one key-value pair;
applying the log comprehension machine learning knowledge model in order to compare data associated with the at least one key-value pair extracted from the log file with knowledge base node key-value pair data; and
based upon the model application, creating mapping results formatted according to the common log schema and compatible with the at least one downstream application.

2. The computer-implemented method of claim 1, further comprising:
transmitting the mapping results to the at least one downstream application.

3. The computer-implemented method of claim 2, further comprising:
updating the knowledge base responsive to log file mapping feedback associated with the at least one downstream application.

4. The computer-implemented method of claim 1, wherein inducting data into the knowledge base comprises:
extracting a plurality of key-value pairs from a log aggregator dataset including semi-structured data;
deriving at least one value feature associated with the plurality of key-value pairs;
deriving any key signal associated with the plurality of key-value pairs; and
adding a node to a plurality of nodes of the knowledge base for each of the plurality of key-value pairs, wherein the node includes the at least one value feature and any key signal derived for the key-value pair.

5. The computer-implemented method of claim 4, wherein inducting data into the knowledge base further comprises:
updating the knowledge base in accordance with the common log schema by pruning at least one node among the plurality of nodes.

6. The computer-implemented method of claim 4, wherein inducting data into the knowledge base further comprises:
updating the knowledge base in accordance with the common log schema by merging multiple nodes among the plurality of nodes.

7. The computer-implemented method of claim 6, wherein merging multiple nodes among the plurality of nodes comprises:
determining whether names of respective key elements of each of the multiple nodes have a semantic meaning exceeding a predetermined key similarity threshold;
determining whether respective relations of each of the multiple nodes have a semantic meaning exceeding a predetermined relation similarity threshold;
determining whether a level of pattern similarity among respective patterns of value elements associated with each of the multiple nodes exceeds a predetermined pattern similarity threshold; and
determining whether a level of key signal similarity of derived key signals associated with each of the multiple nodes exceeds a predetermined key signal similarity threshold.

8. The computer-implemented method of claim 4, wherein inducting data into the knowledge base further comprises:
updating the knowledge base in accordance with the common log schema by splitting a single node among the plurality of nodes.

9. The computer-implemented method of claim 4, wherein inducting data into the knowledge base further comprises:
updating the knowledge base responsive to user feedback.

10. The computer-implemented method of claim 4, wherein extracting the plurality of key-value pairs from the log aggregator dataset comprises:
flattening the log aggregator dataset;
normalizing any universal entity in the flattened log aggregator dataset; and
parsing the plurality of key-value pairs from the flattened log aggregator dataset.

11. The computer-implemented method of claim 4, wherein deriving the at least one value feature associated with the plurality of key-value pairs comprises:
categorizing by value type one or more of the plurality of key-value pairs.

12. The computer-implemented method of claim 4, wherein deriving the at least one value feature associated with the plurality of key-value pairs comprises:
deriving at least one regular expression associated with the plurality of key-value pairs.

13. The computer-implemented method of claim 1, wherein extracting the at least one key-value pair from the log file comprises:
flattening the log file;
normalizing any universal entity in the flattened log file; and
parsing the at least one key-value pair from the flattened log file.

14. The computer-implemented method of claim 1, wherein deriving the at least one value feature associated with the at least one key-value pair comprises:
categorizing by value type one or more of the at least one key-value pair.

15. The computer-implemented method of claim 1, wherein deriving the at least one value feature associated with the at least one key-value pair comprises:
deriving at least one regular expression associated with the at least one key-value pair.

16. A computer program product comprising a computer readable storage medium having program instructions embodied therewith, the program instructions executable by a computing device to cause the computing device to:
induct data into a knowledge base associated with a log comprehension machine learning knowledge model in order to configure a common log schema;
extract at least one key-value pair from a log file including input data associated with at least one downstream application;
derive at least one value feature associated with the at least one key-value pair;
derive any key signal associated with the at least one key-value pair;
apply the log comprehension machine learning knowledge model in order to compare data associated with the at least one key-value pair extracted from the log file with knowledge base node key-value pair data; and
based upon the model application, create mapping results formatted according to the common log schema and compatible with the at least one downstream application.

17. The computer program product of claim 16, wherein the program instructions further cause the computing device to:
update the knowledge base responsive to log file mapping feedback associated with the at least one downstream application.

18. The computer program product of claim 16, wherein deriving the at least one value feature associated with the at least one key-value pair comprises:
categorizing by value type one or more of the at least one key-value pair.

19. A system comprising:
at least one processor; and
a memory storing an application program, which, when executed on the at least one processor, performs an operation comprising:
inducting data into a knowledge base associated with a log comprehension machine learning knowledge model in order to configure a common log schema;
extracting at least one key-value pair from a log file including input data associated with at least one downstream application;
deriving at least one value feature associated with the at least one key-value pair;
deriving any key signal associated with the at least one key-value pair;
applying the log comprehension machine learning knowledge model in order to compare data associated with the at least one key-value pair extracted from the log file with knowledge base node key-value pair data; and
based upon the model application, creating mapping results formatted according to the common log schema and compatible with the at least one downstream application.

20. The system of claim 19, wherein the operation further comprises:
transmitting the mapping results to the at least one downstream application.
